(19) United States
(12) Patent Application Publication
(10) Pub. No.: US 2026/0233079 A1
(43) Pub. Date: Aug. 13, 2026

(54) PROJECTION INDICATION DEVICES AND METHODS

(71) Applicant: Asia Optical Co., Inc., Taichung (TW)

(72) Inventors: Chih-Hsuan Lee, Taichung (TW); Kei Poon, Taichung (TW)

(21) Appl. No.: 19/464,899

(22) Filed: Jan. 30, 2026

(30) Foreign Application Priority Data
Feb. 11, 2025 (TW) 114105019
Dec. 17, 2025 (CN) 202511912284.6

(51) Int. Cl. A63B 71/06; A63B 24/00; A63B 102/16; A63B 102/32; G02B 26/08; G06T 7/70; G09G 3/00

(52) U.S. Cl. CPC A63B 71/0622; A63B 24/0021; G06T 7/70; G09G 3/001; A63B 2024/0034; A63B 2071/0694; A63B 2102/16; A63B 2102/32; A63B 2220/05; A63B 2220/20; A63B 2220/89; A63B 2225/74; G02B 26/0833; G06T 2207/30224; G09G 2340/04

(57) ABSTRACT

A projection indication device includes an image capturing unit, a detection unit, a processing unit, and a projection unit. The image capturing unit acquires an image of a corresponding field. The detection unit detects a field state corresponding to the field and detects a target distance of a first object within the field state. The processing unit, using a calculation module based on the image, determines a first position of the first object and a second position of a second object within the image, and calculates a result based on the first position, the second position, and the target distance. The projection unit projects the result as a projection image onto the field. The length of the projection image varies according to the target distance.

### BACKGROUND OF THE INVENTION

### Field of the Invention

The disclosure relates generally to projection indication devices and methods, and, more particularly to projection indication devices and methods that can integrate image and field detection and utilize projection to assist in ball sports.

### Description of the Related Art

Recently, laser rangefinders have replaced traditional ranging methods as the mainstream ranging system. Laser ranging can be divided into three methods: triangulation, time-of-flight (TOF) measurement, and confocal measurement. Currently, the most common method is time-of-flight (TOF), which measures the round-trip time of the laser beam. The principle of TOF is to use a sight or rangefinder to emit coded laser light from a pulsed infrared source to the target object. The TOF camera receives the laser light reflected back from the target and calculates the distance to the target object using a ranging formula. Due to the unique principle of lasers, measurements can be taken even if the target is inconvenient to approach.

On the other hand, LiDAR technology is becoming increasingly mature and widespread. LiDAR is a sensing technology that emits low-power, eye-safe laser light pulses for measurement and measures the time required for the laser light to complete a round trip between the sensor and the target. The resulting data can be used to generate 3D images, providing spatial position and depth information for identifying, classifying, and tracking moving objects.

In some ball sports, such as golf, beginners often find it difficult to judge the direction and force of their swing. Therefore, this invention provides projection indicator devices and methods as a guide for beginners in ball sports.

### BRIEF SUMMARY OF THE INVENTION

An embodiment of a projection indication device includes an image capturing unit, a detection unit, a processing unit, and a projection unit. The image capturing unit acquires an image of a corresponding field. The detection unit detects a field state corresponding to the field and detects a target distance of a first object within the field state. The processing unit, using a calculation module based on the image, determines a first position of the first object and a second position of a second object within the image, and calculates a result based on the first position, the second position, and the target distance. The projection unit projects the result as a projection image onto the field. The length of the projection image varies according to the target distance.

In an embodiment of a projection indication method, an image of a corresponding field is acquired using an image capturing unit, and a field state corresponding to the field, and a target distance to a first object in the corresponding field state are detected using a detection unit. Then, a first position of the first object and a second position of a second object in the image is determined using a calculation module based on the image, and a result is calculated using the calculation module based on the first position of the first object, the second position of the second object, and the target distance, wherein the result includes a length of a projection image. The length of the projection image is adjusted based on the target distance, and a projection unit is used to project based on the result to display the projection image.

In some embodiments, the result includes a direction and a length of the projection image, and the length of the projection image is positively correlated to the target distance.

In some embodiments, the field state comprises a topographic map, a wind speed, a humidity, a light intensity, an obstacle distribution, or grass line conditions.

In some embodiments, the projection unit includes a light source and a light deflector. The light source emits visible light, which is projected onto the field between the first position and the second position via the light deflector.

In some embodiments, the detection unit includes a laser that emits a vertical cavity surface-emitting laser (VCSEL) using a flash method. The reflected laser beams are received in four zones sequentially by a single-photon avalanche diode (SPAD) sensor, and the target distance is calculated using time-of-flight (ToF) ranging.

In some embodiments, the field comprises a green, a table for table tennis, or golf course. The first object is a flagpole, goal, or hole, and the second object is a ball.

In some embodiments, the projection indication device further comprises a housing, within which the detection unit, the projection unit, and the image capturing unit are disposed. The detection unit is positioned between the projection unit and the image capturing unit, and in use, the projection unit is located away from the plane of the field, while the image capturing unit is located close to the plane of the field.

In some embodiments, the projection indication device meets at least one of the following conditions: 1≤LDF/CF≤2; 92≤(LDP×LDW)/V≤420; 0.7≤PF/CF≤1.5, where LDF is any field of view of the detection unit; CF is any field of view of the image capturing unit; LDP is the pixel value of the detection unit; LDW is the weight of the detection unit; V is the volume of the projection indication device; and PF is any field of view of the projection unit.

In some embodiments, the field state is a topographic map of the green environment, including the condition of the grass lines. The calculation module calculates the trajectory of the golf ball based on the position of the flag stick or hole, the position of the golf ball, the topographic map, and the condition of the grass lines, and obtains the direction and force based on the trajectory.

In some embodiments, the projection unit projects the calculated direction and force to display quantified guide lines.

In some embodiments, the detection unit emits a visible light pattern of a preset shape onto the environmental terrain. The image acquired by the image capturing unit includes the visible light pattern on the environmental terrain and the deformation of the visible light pattern under different terrain undulations. The calculation module correlates the deformation of the pattern in the image with the elevation information of the environmental terrain to identify the undulation characteristics of the environmental terrain.

In some embodiments, when the change in the deformation ratio of the pattern relative to the preset shape does not exceed a preset range, the calculation module can accurately identify the undulation characteristics of the environmental terrain.

If the terrain changes too drastically or does not conform to the characteristics trained on the artificial intelligence model, the calculation module will avoid erroneous output.

In some embodiments, the preset shape is a checkerboard pattern or a dot matrix pattern.

Projection indication methods may take the form of a program code embodied in a tangible media. When the program code is loaded into and executed by a machine, the machine becomes an apparatus for practicing the disclosed method.

The projection indication devices and methods described in the present invention integrate image and laser detection and use projection to assist in ball sports, thereby reducing the difficulty for users in using related assistive devices and further increasing their interest in learning related sports.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a projection indication device of the invention;

FIG. 2 is a schematic diagram illustrating an embodiment of a detection unit of the invention;

FIG. 3 is a schematic diagram illustrating an embodiment of a projection unit of the invention;

FIG. 4 is a schematic diagram illustrating another embodiment of an example of a projection indication device of the invention;

FIG. 5 is a flowchart of an embodiment of a projection indication method of the invention;

FIG. 6 is a flowchart illustrating a projection indication method for a golf ball application according to an embodiment of the invention;

FIG. 7 is a schematic diagram illustrating an example of projection indication according to an embodiment of the invention;

FIG. 8 is a flowchart illustrating another projection indication method 125 according to an embodiment of the invention;

FIGS. 9A and 9B are schematic diagrams illustrating a detection unit projecting a checkerboard pattern onto the environmental terrain using visible light according to an embodiment of the invention; and

FIG. 10 is a schematic diagram illustrating a detection unit projecting a dot matrix pattern onto the environmental terrain using visible light according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

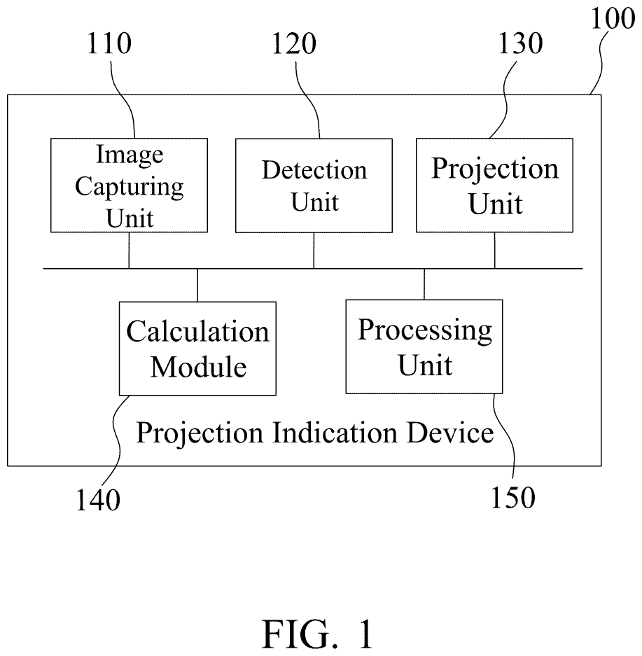

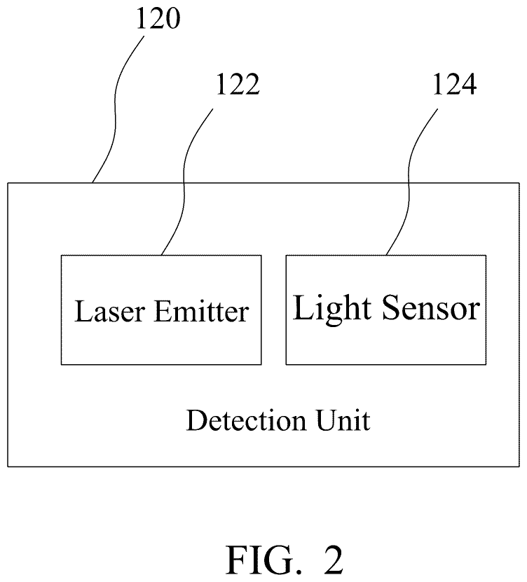

FIG. 1 is a schematic diagram illustrating an embodiment of a projection indication device of the invention. The projection indication device 100 comprises an 140 image capturing unit 110, a detection unit 120, a projection unit 130, a calculation module 140, and a processing unit 150. The image capturing unit 110 may be a camera with at least one lens, used to acquire images of a corresponding field. In some embodiments, the field can be any sport environment, such as a golf green, a billiards table, a cricket field, a pool table, an archery range, etc. It should be noted 145 that the aforementioned fields are merely examples in the application and the invention is not limited thereto. FIG. 2 is a schematic diagram illustrating an embodiment of a detection unit of the invention. The detection unit 120 includes at least a laser emitter 122 and a light sensor 124. In other embodiments, the detection unit may also include an anemometer, a hygrometer, a light intensity meter, an ultrasonic or triangulation ranging module (not shown). In some embodiments, the laser emitter 122 may be a vertical cavity surface-emitting laser (VCSEL) with a wavelength of 905 nm, capable of detecting a range of 8 m and a field of view (FOV) of 60°×45° or 30°×30°. In some embodiments, the light sensor 124 may be a single-photon avalanche diode (SPAD) sensor. It must be noted that the aforementioned laser emitter 122 and light sensor 124 are examples of the application, and the present invention is not limited thereto, any light source can be used in this invention. In some embodiments, the detection unit 120 can use the laser emitter 122 to emit a vertical cavity surface-emitting laser in a flash manner, and use the light sensor 124, such as a single-photon avalanche diode (SPAD) sensor, to receive the reflected laser beams in four zones sequentially, and calculate the distance using time-of-flight (ToF) ranging. The detection unit 120 can detect the field state of the corresponding field, including a topographic map of the terrain undulations, a wind speed, a humidity, a light intensity, an obstacle distribution or grass line conditions, and detect the distance to specific objects in the corresponding field.

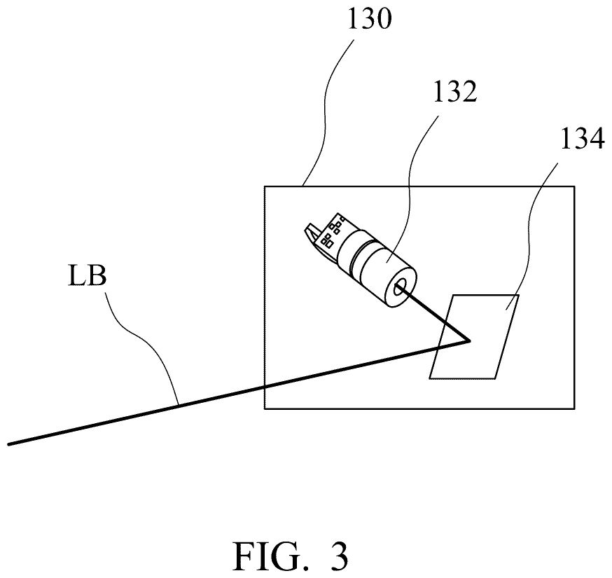

FIG. 3 illustrates a projection unit according to an embodiment of the invention. The projection unit 130 includes at least a light source 132 and a light deflector 134. In some embodiments, the light source 132 may be a 1.3 W, ¢ 9 mm light source using visible light with a wavelength of 650 nm-652 nm, and its projection angle range (field of view of the projection unit) may be 40°×24°. In some embodiments, the light deflector 134 may be a 2D MEMS (Micro-Electro-Mechanical Systems) galvanometer. In one embodiment, the galvanometer size may be 1.0 mm×1.2 mm, but is not limited thereto, as long as the galvanometer area (ML) is 1~1.3 mm² (including 1.3 mm²), and the scanning angle may be: +/−10° (Fast); +/−6° (Slow), and the overall 2D MEMS size (MV) may be 10.8×5.6×2.5 (mm), but is not limited 175 thereto, as long as the 2D MEMS volume (MV) is 150~152 mm² (including 152 mm²). In some embodiments, the light source 132 projects visible light through the light deflector 134. The light deflector 134 directs the laser beam onto a reflector and deflects the laser beam LB by controlling the reflection angle of the reflector, thus projecting a projection image onto a projection surface, such as the ground. In this embodiment, the projection image is a straight line. The direction of the straight line can guide the direction of the shot, and the length of the straight line can represent the force of the shot. In some embodiments, a greater distance indicates a greater force is required, so the force is quantified and displayed by the calculation module as the length of the projection image. It is worth noting that in some embodiments, the projection image can be a curved graphic, an arrow graphic, etc. In some embodiments, the light deflector can be a prism, a plane mirror, or a curved mirror. In some embodiments, a light deflector may not be provided, and the light source projects directly onto a surface or plane.

The calculation module 140 can be trained using an artificial intelligence learning model and can identify the position, the distance, and field state of objects in the images captured by the image capturing unit 110, such as topographic maps, calculate/generate the movement path of specific objects, such as the moving trajectory of a golf ball, billiard ball, or pool ball, and calculate the corresponding movement direction and force. The processing unit 150 can execute the projection indication method of this invention, the details of which will be explained later.

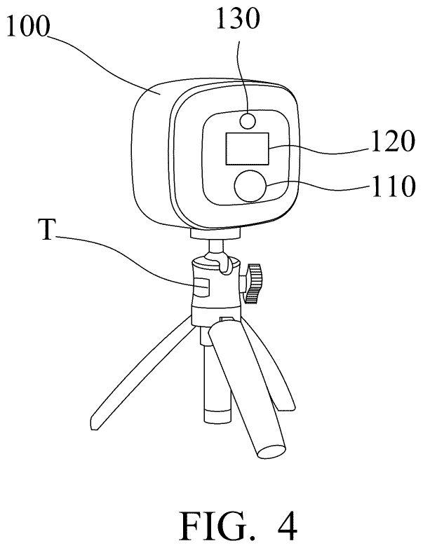

FIG. 4 illustrates an example of a projection indication device according to another embodiment of the invention. In this example, the projection indication device 100 is designed as a cuboid. It is worth noting that the shape of the aforementioned projection indication device is only an example of the application, and the present invention is not limited to any shape. Any shape, such as a circle, cube, or prism, can be applied to the present invention. In this example, the projection indication device 100 can be mounted on a stand T, and the detection unit 120 is disposed between the projection unit 130 and the image capturing unit 110. The projection unit 130, the detection unit 120, and the image capturing unit 110 are arranged sequentially from top to bottom. For example, when the projection indication device 100 of the invention is used on a billiard table, the projection unit 130 is away from the tabletop (plane), and the image capturing unit 110 is close to the tabletop; as another example, if used on a golf ball, the projection unit 130 is away from the green (plane), and the image capturing unit 110 is close to the green. It should be noted that the arrangement of the aforementioned components on the projection indication device 100 is only an example of the application, and the present invention is not limited thereto.

It must be noted that in some embodiments, the projection indication device meets at least one of the following conditions: 1≤LDF/CF≤2; 92≤(LDP×LDW)/V≤420; 0.7≤PF/CF≤1.5, 1064≤((CW×PW)/MV)+PF≤1448, where LDF is any field of view of the detection unit; CF is any field of view of the image capturing unit; LDP is the pixel value of the detection unit; LDW is the weight of the detection unit; V is the volume of the projection indication device; PF is any field of view of the projection unit; CW is the weight of the image capturing unit; PW is the weight of the projection unit; and MV is the volume of the light deflector.

The following table reveals the design parameters and conditions for two embodiments of the application: length is in millimeters (mm), volume is in cubic millimeters (mm³), angle is in degrees, weight is in grams (g), and pixel value is in pixels.

| | V | LDF | CF | PF | LDW | CW | PW | LDP | MV |
|---|---|---|---|---|---|---|---|---|---|
| Embodiment 1 | 3375000 | 60, 45 | 30, 30 | 40, 24 | 15 | 30 | 40 | 240 × 96 | 151.2 |
| Embodiment 2 | 908820 | 30, 30 | 30, 30 | 40, 40 | 15 | 30 | 40 | 240 × 96 | 151 |

| | | | (LDP × | | | ((CW × PW)/ |
|---|---|---|---|---|---|---|
| | LDF/CF | | LDW)/V | PF/CF | | MV) + PF |
| Embodiment 1 | 2 | 1.5 | 0.1024 | 1.3 | 0.8 | 967.9 |
| Embodiment 2 | 1 | 1 | 0.3803 | 1.3 | 1.3 | 1607.9 |

It is worth noting that, taking the LDF of Example 1 as an example, its field of view can be 60 degrees×60 degrees, 60 degrees×45 degrees, or 45 degrees×45 degrees, and other field of view angles are similar thereto. It must also be noted that the above table is only an embodiment of the application, and the present invention is not limited thereto.

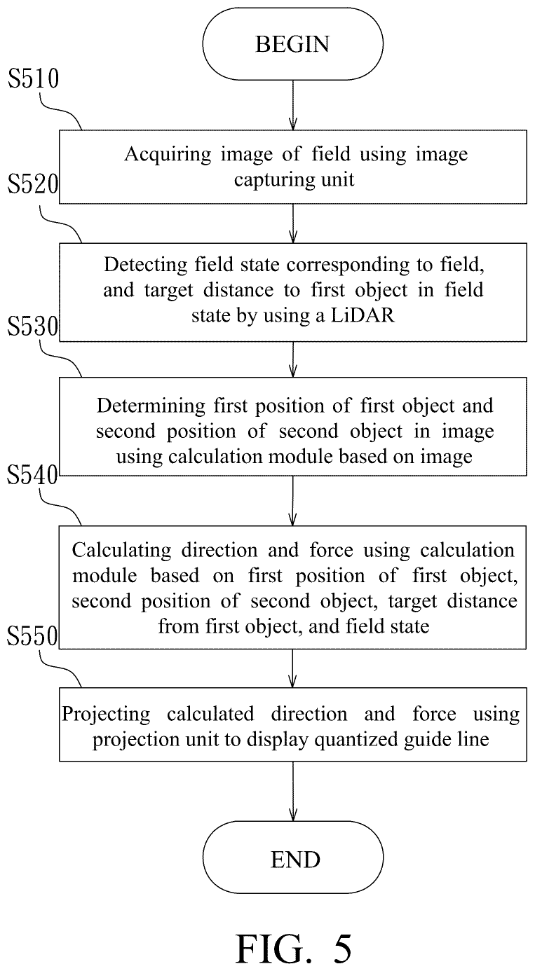

FIG. 5 illustrates a projection indication method according to an embodiment of the invention. The projection indication method according to an embodiment of the invention is applicable to an electronic device, such as the projection indication device shown in FIG. 1.

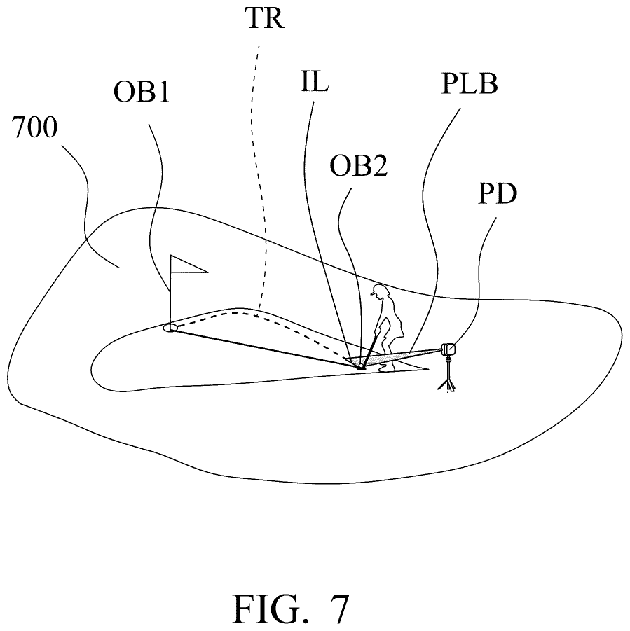

First, in step S510, an image of a corresponding field is acquired using the image capturing unit. It is worth noting that in some embodiments, the field can be any environment in which the sport is played, such as a golf green, a billiards table, a cricket field, an archery range, etc. It should be noted that the aforementioned fields are merely examples in the application, and the invention is not limited thereto. In step S520, a field state corresponding to the field is detected using a laser, and a distance to the first object in the corresponding field state (hereinafter referred to as the target distance) is detected. As mentioned earlier, in some embodiments, the laser can emit a vertical cavity surface-emitting laser in a flash manner, and receive the reflected laser beams in four zones sequentially using a single-photon avalanche diode sensor, and calculate the distance using time-of-flight ranging. In some embodiments, the field state can be a topographic map including terrain undulations. Then, in step S530, based on the image acquired by the image capturing unit, a calculation module determines a first position of the first object and a second position of a second object in the image. It should be noted that in some embodiments, the aforementioned field can be the green environment of a corresponding golf course, and the first object is a flagstick or hole, and the second object is a golf ball. In some embodiments, the aforementioned field can be a billiard table, and the first object is a hole, and the second object is a billiard ball. It must be noted that the aforementioned field, first object, and second object are merely examples of the application, and the present invention is not limited thereto. In step S540, a direction and a force are calculated using the calculation module based on the first position of the first object, the second position of the second object, the target distance from the first object, and the field state. It is worth noting that in some embodiments, the projection indication device may include an inertial sensor to detect the attitude data corresponding to the projection indication device. In some embodiments, the calculation module may further calculate the direction and force based on the attitude data. It should be noted that in some embodiments, the calculation module may correct the aforementioned target distance based on the first position of the first object and the second position of the second object. Afterwards, in step S550, the calculated direction and force are projected using a projection unit to display a quantized guide line. As mentioned above, the projection unit may project visible light through a light deflector. The light deflector directs the laser onto a reflector and deflects the laser by controlling the reflection angle of the reflector, thus projecting a guide line onto a projection surface, such as the ground. It is worth noting that in some embodiments, the guide line can be a straight line, a curve, or an arrow. It is worth noting that in some embodiments, greater distance indicates a greater force required. Therefore, the calculation module quantifies the force as the length of the projection image. In other embodiments, headwinds, surface roughness, or grass line conditions also affect the force. Therefore, in this further embodiment, the calculation unit adjusts the image length based on the target distance, wind speed, humidity, light intensity, obstacle distribution, or grass line conditions. In some embodiments, the flagpole, goal, or hole and the ball are not on the same plane; therefore, an angle (not shown) also affects the force. Using FIG. 7 as an example, the flagpole OB1 is at the top of the hillside, and the golf ball OB2 is at the bottom of the hillside, at which point the angle is an elevation angle; or the flagpole OB1 is at the bottom of the hillside, and the golf ball OB2 is at the top of the hillside, at which point the angle is a depression angle. The calculation unit calculates this angle and adjusts the image length accordingly. When the angle is an elevation angle, the larger the elevation angle, the longer the image length; when the angle is a depression angle, the larger the depression angle, the shorter the image length. In summary, the image length is positively correlated or proportional to the target distance. It is worth noting that the image length of a target that is far away but has a small elevation angle may be the same as the image length of a target that is close to the target but has a large elevation angle. In addition, in some embodiments, the projection unit can display this guide line at the second position of the corresponding second object.

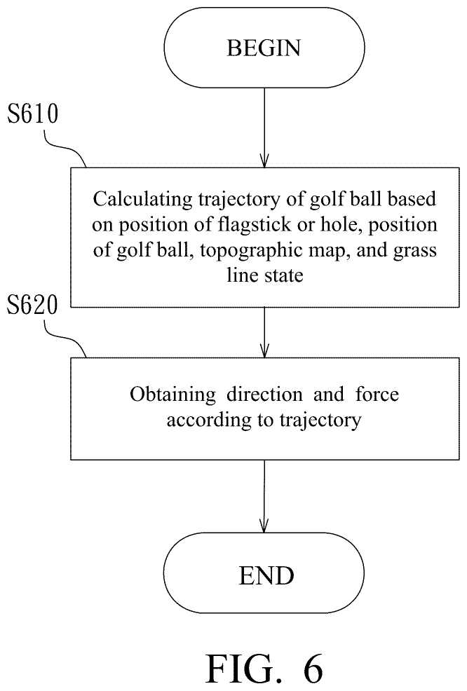

As described, in some embodiments, the field can be the green environment of a corresponding golf course, and the first object is a flagstick or hole, and the second object is a golf ball. FIG. 6 shows a method for calculating the direction and force of a golf ball application according to an embodiment of the invention. In this embodiment, the field state can be a topographic map of the green environment, and the field state includes the grass line state of the green environment, i.e., the growth direction of the grass on the green. First, in step S610, the calculation module calculates the trajectory of the corresponding golf ball based on the position of the flagstick or hole, the position of the golf ball, the topographic map, and the grass line state, and in step S620, obtains the direction and force according to the trajectory. Similarly, the projection unit can project based on the calculated direction and force to display a quantized guide line. Similarly, the guide line can be a straight line or a curve, and the quantized guide line will be longer when the force is greater. In addition, in some embodiments, the projection unit can display this guide line at the 305 position of the golf ball.

FIG. 7 illustrates an example of projection indication according to an embodiment of the invention. In this example, there is a flagstick OB1 and a golf ball OB2 on the green 700, and the projection indication device PD can be placed at a distance of about 1 meter behind the golf ball OB2. The projection indication device PD can acquire an image of the green 700 including the flagstick OB1 and the golf ball OB2 through the image capturing unit, and the light of the projection indication device PD can detect the field state of the entire green environment, i.e., the topographic map, the flagstick OB1, the golf ball OB2, and the state of the grass lines. Based on the position of the flagstick, the position of the golf ball, the topographic map, and the state of the grass lines, the calculation module of the projection indication device PD can calculate the trajectory TR that the golf ball OB2 should travel, as well as the corresponding direction and force. The projection unit of the projection indication device PD can perform laser projection PLB according to the calculated direction and force to display a quantified guide line IL on the grass. Therefore, the user can control the direction and force of the shot according to the direction and length of the guide line IL.

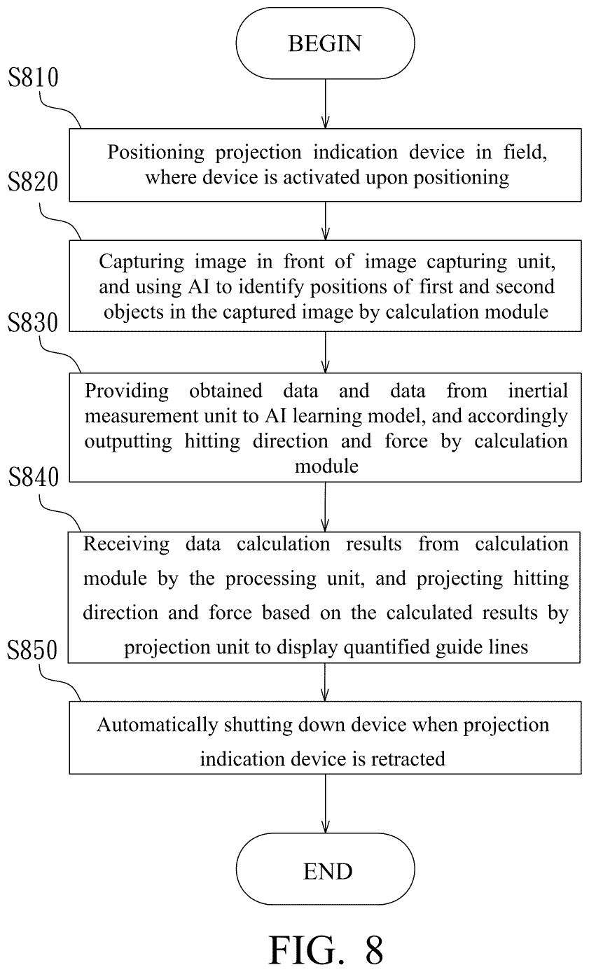

FIG. 8 is a flowchart illustrating another projection indication method according to an embodiment of the invention.

First, In step S810, the projection indication device is positioned in the corresponding field, and the device is activated upon positioning. This field can be any sports environment, such as a golf green. The aforementioned field is merely an example in the application, and the invention is not limited thereto. Taking a golf green as an example, the projection indication device can be placed facing the flagstick, one meter behind the ball.

Then, in step S820, the image capturing unit 110 captures the image in front of itself, and the calculation module 140 uses artificial intelligence to identify the positions of the corresponding first and second objects in the image captured by the image capturing unit 110. For example, after the image capturing unit 110 captures the image of the ball and the flagstick on the golf course, the calculation module 140 uses artificial intelligence to determine the positions of the ball and the flagstick. Simultaneously, the laser is activated to detect the distance between the first and second objects and the corresponding field state. For example, the laser is used to detect the distance between the ball and the flagstick and to detect the green terrain.

In step S830, the data obtained in step S820, along with the data from the inertial measurement unit, are provided to the artificial intelligence learning model of the calculation module 140. Based on this, the calculation module 140 outputs the hitting direction and force. The calculation module 140 can be trained using an artificial intelligence learning model and can identify the position, distance, and field state of objects in images captured by the image acquisition unit 110, such as topographic maps, to calculate/generate the motion path of specific objects, such as the moving trajectory of a golf ball, billiard ball, or pool ball, and calculate the corresponding movement direction and force.

In step S840, the processing unit 150 receives the data calculation results output by the calculation module 140. The projection unit 130 can project the hitting direction and force based on the calculated results to display quantified guide lines.

In step S850, when the projection indication device is retracted, the device automatically shuts down.

In one embodiment of the invention, the detection unit 120 may include a visible light emitting element (not shown), thereby enabling the detection unit 120 to emit a visible light pattern of a preset shape and project it onto the environmental terrain. The preset visible light pattern is preferably a regular shape, such as a checkerboard pattern or a dot matrix pattern. A regular shape means that when projected by the detection unit 120, the shape of the visible light pattern is regular. If projected onto a plane perpendicular to the projection path, a regular pattern is formed.

When visible light patterns are shone onto the terrain, the resulting patterns will also undergo corresponding deformations as the terrain undulates. For example, the curvature and direction of the lines in the pattern, changes in the proportion of the pattern, and relative changes in the distribution of light and shadow and the projection position.

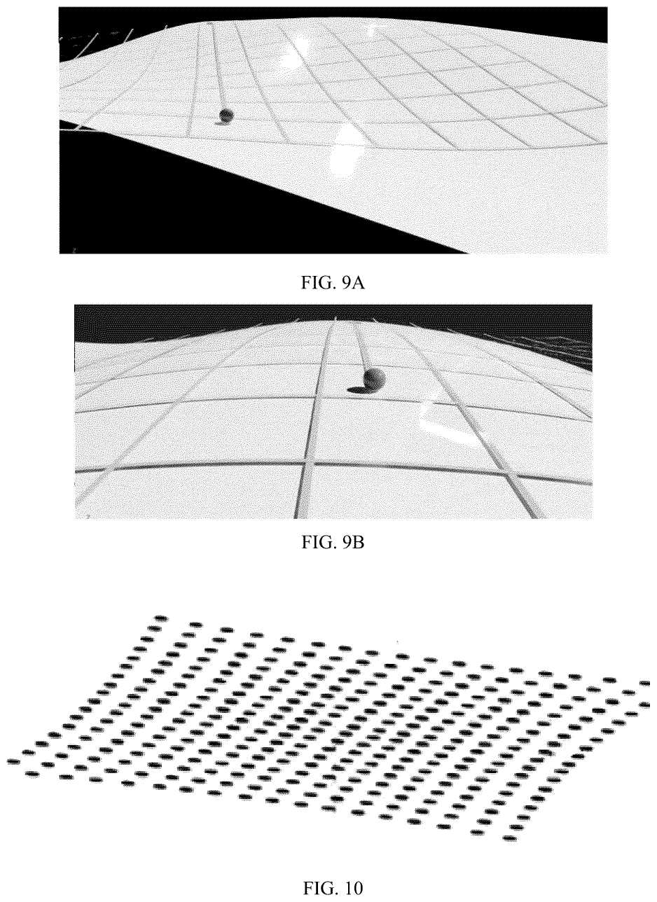

As shown in FIGS. 9A and 9B, the dimensions and shape of the checkerboard pattern cells change as the terrain changes after being projected onto the surrounding landscape. Similarly, as shown in FIG. 10, the spacing and shape of the dotted patterns in the grid pattern change with the terrain.

When the image capturing unit 110 captures an image of the corresponding field, the image contains a visible light pattern of the detection unit 120 hitting the environmental terrain, as well as the deformation of the visible light pattern under different terrain undulations. The images captured by the image capturing unit 110 are then input into the artificial intelligence learning model of the calculation module 140.

The artificial intelligence model of calculation module 140 learns the deformation features of graphics in the image, such as the curvature and direction of the lines in the checkerboard pattern in FIGS. 9A and 9B as the terrain changes, the scale of the checkerboard changes as the terrain changes, and the relative changes in the distribution of light and shadow and the projection position, thereby extracting features.

After being trained on a large number of terrains with varying slopes and undulations, the artificial intelligence model of the calculation module 140 can correlate the deformation of graphics in an image with the undulations of the surrounding terrain. For example, when the checkerboard pattern in FIGS. 9A and 9B changes with terrain, with lines expanding outwards or spacing increasing, it indicates that the area is a protrusion or uphill. When the lines converge or spacing decreases, it indicates that the area is a depression or downhill. In a specific implementation, when the change in the graphic's proportion relative to the aforementioned preset shape does not exceed a preset range, the artificial intelligence model can accurately identify the undulations of the surrounding terrain. If the terrain changes too drastically or does not conform to the characteristics trained on the artificial intelligence model, calculation module 140 will avoid erroneous output.

For example, if the spacing or aspect ratio of the checkerboard pattern changes by approximately ±30% to ±40% relative to a preset planar graphic (i.e., in its undeformed state), the AI model can still accurately identify it. If the change exceeds this preset range, the computer module 140 will determine that it exceeds the feature distribution trained on by the AI model and mark it as an uncertain area, prompting a re-shoot. As another example, if the curvature of the checkerboard lines corresponds to a radius of curvature of approximately 3 meters or more (i.e., a relatively gentle terrain), the AI model can identify gentle slopes and moderately curved surfaces commonly found on greens. However, if the radius of curvature is too small (less than approximately 3 meters, indicating severe unevenness or unnatural deformation), the AI model will be unable to interpret the deformation due to it exceeding its training experience, and the output will also be marked as an uncertain area.

For example, if the area, side length, or spacing of a dot matrix pattern changes by approximately ±30% to ±40% relative to a pattern generated on a plane, the artificial intelligence model can still accurately identify the undulation features that are different from those on a plane.

This invention is not limited to this. In addition to learning the geometric changes of checkerboard lines, the artificial intelligence model also learns features under different lighting conditions. For example, the model can be trained using multiple sets of image data with different lighting distributions but the same projection position. This allows it to learn which changes are caused by ambient light and which are deformations caused by the terrain itself, thus identifying terrain features based on the lighting distribution in the images.

For example, images of the same terrain under different brightness, shadow directions, or reflection conditions can be input into the artificial intelligence model. When the same terrain still corresponds to the same terrain height under different brightness, shadow directions, or reflection conditions, the artificial intelligence model learns to ignore brightness changes caused by illumination and only retain the geometric features of lines related to terrain undulations, such as line curvature and proportional changes. This enables the artificial intelligence model to maintain stable terrain judgments under natural light or shadow conditions.

Furthermore, the training data input into the artificial intelligence model can also include samples of slight changes in the projection position of visible light patterns, such as slight camera angle deviations or slight shifts in the projection grid. By combining these images with minor differences but still labeled as having the same terrain result, the artificial intelligence model can further learn that projection geometric translation is not equivalent to terrain change, thereby reducing the impact of slight positional changes in the detection unit 120 or the capturing unit 110 on the interpretation results.

Therefore, in practical applications, even with different external lighting conditions, consistent and reliable terrain judgment results can be output.

Finally, the calculation module 140 can generate a terrain height distribution map or a slope vector map to produce corresponding shot angle and power suggestions. Similar parts to other embodiments described above will not be repeated.

In another embodiment of this application, the detection unit 120 and the projection unit 130 can be combined into one, and the projection unit 130 can project a preset shape of visible light pattern onto the environmental terrain. Further details are omitted here.

Therefore, the projection indications devices and methods of the present invention can integrate image and light detection and use projection to assist in ball sports, thereby reducing the difficulty for users to use related auxiliary equipment and further increasing their interest in learning related sports.

Projection indication methods may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A projection indication device, comprising:
an image capturing unit for acquiring an image of a corresponding field;
a detection unit for detecting a field state corresponding to the field and detecting a target distance of a first object in the corresponding field state;
a processing unit for determining, using a calculation module based on the image, a first position of the first object and a second position of a second object in the image, and calculating a result based on the first position of the first object, the second position of the second object, and the target distance; and
a projection unit for projecting the result as a projection image onto the field,
wherein, a length of the projection image varies according to the target distance, the result includes a direction and the length of the projection image, and the length of the projection image is positively correlated or proportional to the target distance.

2. The device as claimed in claim 1, wherein the projection unit includes a light source and a light deflector, wherein the light source emits visible light to project the projection image between the first position and the second position in the field via the light deflector, and the projection indication device meets at least one of the following conditions:
$$1 ≦ LDF / CF ≦ 2 ;$$
$$92 ≦ ( LDP \times LDW ) / V ≦ 420 ;$$
$$0.7 ≦ PF / CF ≦ 1.5 ;$$
$$967.9 ≦ ( ( CW \times PW ) / MV ) + PF ≦ 1607.9 ,$$
where LDF is any field of view of the detection unit, CF is any field of view of the image capturing unit, LDP is a pixel value of the detection unit, LDW is a weight of the detection unit, V is a volume of the projection indication device, and PF is any field of view of the projection unit, CW is a weight of the image capturing unit, PW is a weight of the projection unit, MV is a volume of the light deflector, and PF is any field of view of the projection unit.

3. The device as claimed in claim 2, wherein the field state comprises a topographic map, a wind speed, a humidity, a light intensity, an obstacle distribution, or grass line conditions.

4. The device as claimed in claim 2, wherein the detection unit comprises a Lidar that emits a vertical cavity surface-emitting laser (VCSEL) using a flash method and receives reflected laser beams in four zones sequentially by a single-photon avalanche diode (SPAD) sensor, and calculates the target distance using time-of-flight (ToF) ranging.

5. The device as claimed in claim 2, wherein the field comprises a green, a table for table tennis or a golf course, the first object comprises a flagpole, a goal, or a hole, and the second object comprises a ball.

6. The device as claimed in claim 2, further comprising a housing, in which the detection unit, the projection unit, and the image capturing unit are disposed, with the detection unit positioned between the projection unit and the image capturing unit, and in a use state, the projection unit is located away from a plane of the field, and the image capturing unit is located close to that plane of the field.

7. The device as claimed in claim 1, wherein the detection unit emits a visible light pattern of a preset shape and projects it onto an environmental terrain of the field, and the image acquired by the image capturing unit comprises the visible light pattern projected onto the environmental terrain, as well as a deformation of the visible light pattern under different terrain undulations, and the calculation module correlates the deformation of the visible light pattern in the image with elevation information of the environmental terrain to identify undulation characteristics of the environmental terrain.

8. The device as claimed in claim 7, wherein when a deformation ratio of the image relative to the preset shape does not exceed a preset range, the calculation module can accurately identify the undulation characteristics of the environmental terrain, and if the terrain changes too drastically or does not conform to the characteristics trained on an artificial intelligence model, the calculation module will avoid erroneous output.

9. The device as claimed in claim 8, wherein the preset shape is a checkerboard pattern or a dot matrix pattern.

10. A projection indication device, comprising:
an image capturing unit for acquiring an image of a corresponding field;
a detection unit for detecting a field state corresponding to the field and detecting a target distance of a first object in the corresponding field state;
a processing unit for determining, using a calculation module based on the image, a first position of the first object and a second position of a second object in the image, and calculating a result based on the first position of the first object, the second position of the second object, and the target distance;
a projection unit for projecting the result as a projection image onto the field,
wherein a length of the projection image varies according to the distance, and the projection indication device meets at least one of the following conditions:
$$1 ≦ LDF / CF ≦ 2 ;$$
$$92 ≦ ( LDP \times LDW ) / V ≦ 420 ;$$
$$0.7 ≦ PF / CF ≦ 1.5 ,$$
where LDF is any field of view of the detection unit, CF is any field of view of the image capturing unit, LDP is a pixel value of the detection unit, LDW is a weight of the detection unit, V is a volume of the projection indication device, and PF is any field of view of the projection unit.

11. The device as claimed in claim 10, wherein the projection unit includes a light source and a light deflector, wherein the light source emits visible light to project the projection image between the first position and the second position in the field via the light deflector, and the projection indication device meets the condition 967.9≤((CW×PW)/MV)+PF≤1607.9, where CW is a weight of the image capturing unit, PW is a weight of the projection unit, MV is a volume of the light deflector, and PF is any field of view of the projection unit.

12. The device as claimed in claim 11, wherein the field state comprises a topographic map, a wind speed, a humidity, a light intensity, an obstacle distribution, or grass line conditions.

13. The device as claimed in claim 11, wherein the detection unit comprises a Lidar that emits a vertical cavity surface-emitting laser (VCSEL) using a flash method and receives reflected laser beams in four zones sequentially by a single-photon avalanche diode (SPAD) sensor, and calculates the target distance using time-of-flight (ToF) ranging.

14. The device as claimed in claim 11, wherein the field comprises a green, a table for table tennis or a golf course, the first object comprises a flagpole, a goal, or a hole, and the second object comprises a ball.

15. The device as claimed in claim 11, further comprising a housing, in which the detection unit, the projection unit, and the image capturing unit are disposed, with the detection unit positioned between the projection unit and the image capturing unit, and in a use state, the projection unit is located away from a plane of the field, and the image capturing unit is located close to that plane of the field.

16. The device as claimed in claim 10, wherein the detection unit emits a visible light pattern of a preset shape and projects it onto an environmental terrain of the field, and the image acquired by the image capturing unit comprises the visible light pattern projected onto the environmental terrain, as well as a deformation of the visible light pattern under different terrain undulations, and the calculation module correlates the deformation of the visible light pattern in the image with elevation information of the environmental terrain to identify undulation characteristics of the environmental terrain.

17. The device as claimed in claim 16, wherein when a deformation ratio of the image relative to the preset shape does not exceed a preset range, the calculation module can accurately identify the undulation characteristics of the environmental terrain, and if the terrain changes too drastically or does not conform to the characteristics trained on an artificial intelligence model, the calculation module will avoid erroneous output.

18. The device as claimed in claim 17, wherein the preset shape is a checkerboard pattern or a dot matrix pattern.

19. A projection indication method, comprising:
acquiring an image of a corresponding field using an image capturing unit;
detecting a field state, and a target distance to a first object within the field state using a detection unit;
determining a first position of the first object and a second position of a second object within the image using a calculation module based on the image;
calculating a result comprising a length of a projection image based on the first position of the first object, the second position of the second object, and the target distance;
adjusting a length of the projection image based on the target distance; and
using a projection unit to project based on the result to display the projection image, wherein the projection unit includes a light source emitting visible light to project the projection image between the first position 14 and the second position in the field,
and the projection indication device meets at least one of the following conditions:
$$1 ≦ LDF / CF ≦ 2 ;$$
$$92 ≦ ( LDP \times LDW ) / V ≦ 420 ;$$
$$0.7 ≦ PF / CF ≦ 1.5$$
$$967.9 ≦ ( ( CW \times PW ) / MV ) + PF ≦ 1607.9 ,$$
where LDF is any field of view of the detection unit, CF is any field of view of the image capturing unit, LDP is a pixel value of the detection unit, LDW is a weight of the detection unit, Vis a volume of the projection indication device, PF is any field of view of the projection unit, CW is a weight of the image capturing unit, PW is a weight of the projection unit, and MV is a volume of a light deflector.

20. The device as claimed in claim 19, wherein the detection unit emits a visible light pattern of a preset shape and projects it onto an environmental terrain of the field, and the image acquired by the image capturing unit comprises the visible light pattern projected onto the environmental terrain, as well as a deformation of the visible light pattern under different terrain undulations, and the calculation module correlates the deformation of the visible light pattern in the image with elevation information of the environmental terrain to identify undulation characteristics of the environmental terrain, and when a deformation ratio of the image relative to the preset shape does not exceed a preset range, the calculation module can accurately identify the undulation characteristics of the environmental terrain, and if the terrain changes too drastically or does not conform to the characteristics trained on an artificial intelligence model, the calculation module will avoid erroneous output.
